(19) United States
(12) Patent Application Publication
(10) Pub. No.: US 2012/0143602 A1
(43) Pub. Date: Jun. 7, 2012

(54) SPEECH DECODER AND METHOD FOR DECODING SEGMENTED SPEECH FRAMES

(75) Inventors: Kyung Jin BYUN, Daejeon (KR); Nak Woong EUM, Daejeon (KR); Hee-Bum JUNG, Daejeon (KR)

(73) Assignee: ELECTRONICS AND TELECOMMUNICATIONS RESEARCH INSTITUTE, Daejeon (KR)

(21) Appl. No.: 13/191,007

(22) Filed: Jul. 26, 2011

(30) Foreign Application Priority Data
Dec. 1, 2010 (KR) 10-2010-0121590

(51) Int. Cl. G10L 19/00

(52) U.S. Cl. 704/219; 704/201; 704/E19.001

(57) ABSTRACT

A method for decoding segmented speech frames includes: generating parameters of a segmented current speech frame by using parameters of a segmented previous speech frame; and decoding a speech frame by using the parameters of the current speech frame, which are generated in the generating of the parameters of the segmented current speech frame.

### CROSS-REFERENCE(S) TO RELATED APPLICATIONS

The present application claims priority of Korean Patent Application No. 10-2010-0121590, filed on Dec. 1, 2010, which is incorporated herein by reference in its entirety.

### BACKGROUND OF THE INVENTION

1. Field of the Invention

Exemplary embodiments of the present invention relate to an electronic device, and more particularly, to a speech decoder and method for decoding segmented speech frames.

2. Description of Related Art

Recent mobile communication systems or digital multimedia storage devices have used various types of speech coding algorithms to maintain an original state for a speech quality, while using a smaller number of bits than a speech signal. In general, a code excited linear prediction (CELP) algorithm is one of effective coding schemes which maintain a high quality even at a low transmission rate of 8-16 kbps. An algebraic CELP coding scheme, which is one of the CELP coding schemes, is such a successful method as to be adopted in many recent worldwide standards such as G.729, enhanced variable rate coding (EVRC), and adaptive multi-rate (AMR) speech codec. However, when such CELP algorithms are carried out at a bit rate of 4 kbps or less, the speech quality is rapidly degraded. Therefore, it is known that the CELP algorithms are not suitable for application fields using a low bit rate.

Waveform interpolation (WI) coding is one of speech coding schemes which guarantee a high speech quality even at a low bit rate of 4 kbps or less. In the WI coding, four parameters of a linear prediction (LP) parameter, a pitch value, power, and a characteristic waveform (CW) are extracted from an inputted speech signal. Among the parameters, the CW parameter is segmented into two parameters of a slowly evolving waveform (SEW) and a rapidly evolving waveform (REW). Since the SEW and REW parameters have different characteristics from each other, the SEW and REW parameters are separately quantized to increase coding efficiency.

Meanwhile, a speech synthesizer serves to receive a text and synthesize a speech signal. Many recent synthesizers have been implemented by using a technology which connects speech segments such as diphones or triphones by using a TD-PSOLA (time domain pitch synchronous overlap add) algorithm or the like. Such high-quality speech synthesizers require a memory space for storing a large amount of speech database. Such a memory space may serve as an obstacle to implementing a portable embedded speech synthesizer.

In a speech synthesizer, it is very efficient to use a speech codec as a method for compressing speech database. However, the speech codec used in the speech synthesizer has a difference from a speech codec which is generally used in a communication field. The speech codec in the communication field consecutively performs encoding and decoding for consecutive speech signals. Therefore, once the speech codec starts to operate, the speech codec continuously maintains filter memories and parameters of a previous frame required for processing a current frame. Therefore, the parameters of the previous frame may be used when the current frame is decoded.

However, the speech synthesizer should be able to decode an arbitrary frame of compressed speech frames, in order to restore speech segments required by the speech synthesizer. In such a case, when a general codec is used to perform decoding, many of the restored speech signals may be deteriorated. In particular, when a decoder decodes a first frame at which decoding is started, deterioration frequently occurs, because the decoder does not have parameters for a previous frame of the first frame.

The above-described related art may include technology information which the present inventor has retained to derive the present invention or has learned while deriving the present invention, and may not a known technology which has been published before the application of the present invention.

### SUMMARY OF THE INVENTION

An embodiment of the present invention is directed to a decoder and method for decoding segmented speech frames which is based on a WI decoding scheme capable of decoding an arbitrary segmented frame without a reduction in speech quality.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a method for decoding segmented speech frames includes: generating parameters of a segmented current speech frame by using parameters of a segmented previous speech frame; and decoding a speech frame by using the parameters of the current speech frame, which are generated in the step of generating the parameters of the segmented current speech frame.

The step of generating the parameters of the segmented current speech frame may include: interpolating REW magnitude information of the current speech frame and REW magnitude information of the previous speech frame and generating REW information of the previous speech frame; interpolating SEW information of the previous speech frame, which is generated from SEW magnitude information of the previous speech frame, and SEW information of the current speech frame, which is generated from SEW magnitude information of the current speech frame, and generating SEW information of the previous speech frame; and combining information generated by interpolating the SEW information of the previous speech frame and SEW information of a speech frame before the previous speech frame and information generated by interpolating the REW information of the previous speech frame and REW information of the speech frame before the previous speech frame, and generating CW information of the previous speech frame.

In the step of generating the parameters of the segmented current speech frame, an LP coefficient, a pitch value, CW power, REW information, and SEW information of the previous speech frame may be further used to generate the parameters of the current speech frame.

In the step of generating the parameters of the segmented current speech frame, phase information of a last sample of the previous speech frame may be further used to generate the parameters of the current speech frame.

The step of generating the parameters of the segmented current speech frame may include interpolating the phase information of the last sample and phase information calculated for a first sample of the current speech frame.

In accordance with another embodiment of the present invention, a speech decoder for decoding segmented speech frames includes: a preprocessing block configured to generate parameters of a segmented current speech frame by using parameters of a segmented previous speech frame; and a decoding block configured to decode a speech frame by using the parameters of the current speech frame which are generated by the preprocessing block.

The preprocessing block may include: an REW information generation unit configured to interpolate REW magnitude information of the current speech frame and REW magnitude information of the previous speech frame and generate REW information of the previous speech frame; an SEW information generation unit configured to interpolate SEW information of the previous speech frame, which is generated from SEW magnitude information of the previous speech frame, and SEW information of the current speech frame, which is generated from SEW magnitude information of the current speech frame, and generate SEW information of the previous speech frame; and a CW information generation unit configured to combine information generated by interpolating the SEW information of the previous speech frame and SEW information of a speech frame before the previous speech frame and information generated by interpolating the REW information of the previous speech frame and REW information of the speech frame before the previous speech frame, and generate CW information of the previous speech frame.

The preprocessing block may generate the parameters of the current speech frame by further using an LP coefficient, a pitch value, CW power, REW information, and SEW information of the previous speech frame.

The preprocessing block may generate the parameters of the current speech frame by further using phase information of a last sample of the previous speech frame.

The preprocessing block may include a phase information unit configured to interpolate the phase information of the last sample and phase information calculated for a first sample of the current speech frame.

### BRIEF DESCRIPTION OF THE DRAWINGS

FIG. 1 is an encoder block diagram of a WI speech codec which is generally used.

FIG. 2 is a decoder block diagram of the WI speech codec which is generally used.

FIG. 3 is a diagram showing a process of decoding segmented speech frames.

FIG. 4 is a diagram illustrating a decoder structure for decoding segmented speech frames in accordance with an embodiment of the present invention.

FIG. 5 is a diagram illustrating the detailed structure of a pre-processing block of FIG. 4.

FIG. 6 is a block diagram of a decoder for decoding segmented speech frames in accordance with an embodiment of the present invention.

FIG. 7 is a flow chart showing a method for decoding segmented speech frames in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein, but it should be understood that the idea of the present invention should be construed to extend to any alterations, equivalents and substitutes besides the accompanying drawings.

Although terms like a first and a second are used to describe various elements, the elements are not limited to the terms. The terms are used only to discriminate one element from another element. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Like reference numerals refer to like elements throughout the descriptions of the figures, and the duplicated descriptions thereof will be omitted. When it is determined that a specific description for the related known technology unnecessarily obscures the purpose of the present invention, the detailed descriptions thereof will be omitted. Furthermore, before exemplary embodiments of the present invention are described in detail, the operation of an existing WI speech codec which is generally used in such a communication field will be first described.

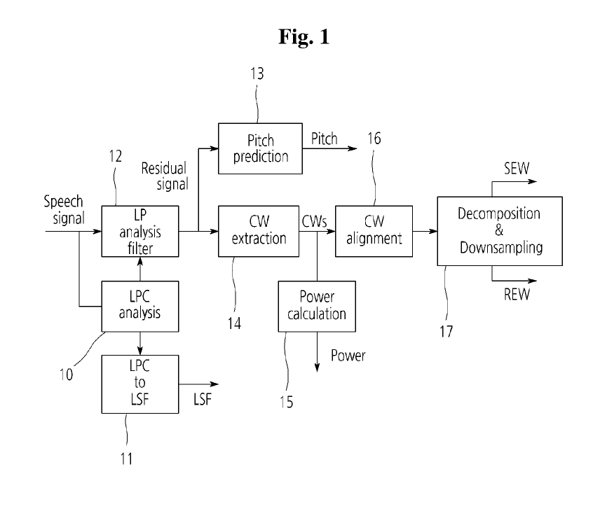

FIG. 1 is an encoder block diagram of a WI speech codec which is generally used.

Referring to FIG. 1, respective parameters are extracted, with one frame consisting of 320 samples (20 msec) of a speech signal sampled at about 16 kHz. First, the WI speech codec performs a LP analysis on an input speech signal once per frame, and extracts LPC coefficients (10). The extracted LPC coefficients are converted into line spectrum frequency (LSF) coefficients for efficient quantization, and the quantization is then performed by using a variety of vector quantization methods (11). When the input speech signal passes through an LP analysis filter which is configured with the LPC coefficients, an LP residual signal is acquired (12). In order to obtain a pitch value from the LP residual signal, pitch prediction is performed (13). The prediction method for obtaining a pitch value may include a variety of methods, but a pitch prediction method using autocorrelation has been used herein. After the pitch value is obtained, the WI speech codec extracts characteristic waveforms (CW) having the obtained pitch value at a predetermined period from the LP residual signal (14). The CWs are usually expressed as Equation 1 below by using the discrete time Fourier series (DTFS).

$$u ( n , φ ) = {\sum }_{k = 1}^{[ P ( n ) / 2 ]} [ {A}_{k} ( n ) cos ( k φ ) + {B}_{k} ( n ) sin ( k φ ) ] 0 \leq φ ( \cdot ) \leq 2 π \qquad ( 1 )$$

Here, Φ=Φ(m)=2πm/P(n), Aₖ and Bₖ represent DTFS coefficients, and P(n) represents a pitch value. In result, the CW extracted from the LP residual signal is the same as a waveform of a time domain transformed by the DTFS. Since the CWs are generally not in phase along the time axis, it is required to smooth down the CWs as flat as possible in the direction of the time axis. Such an alignment process is performed through a circular time shift to align a currently extracted CW to a previously extracted CW (16). The DTFS expression of a CW may be considered as a waveform extracted from a periodic signal, and thus the circular time shift can may considered as the same process as adding a linear phase to the DTFS coefficients. After the CW alignment process, the CWs are power-normalized and then quantized (15). Such a power normalization process is required for improving coding efficiency by separating the CW into the shape and power and separately quantizing them.

When the extracted CWs are arranged on the time axis, a two-dimensional surface is formed. The CWs configured with a two-dimensional surface are decomposed into a SEW and REW which are two independent elements, through low-pass filtering. The SEW and REW each are processed by a downsampling scheme, and then finally quantized (17). As a result, the SEW represents a periodic signal (voiced component) most, and the REW represents a noise-like signal (unvoiced component) most. Since the components have very different characteristics from each other, the coding efficiency is improved by dividing and separately quantizing the SEW and REW. Specifically, the SEW is quantized to have high accuracy and a low transmission rate, and the REW is quantized to have low accuracy and a high transmission rate. Thereby, a final sound quality can be maintained. In order to use such characteristics of a CW, a two-dimensional CW is processed via low-pass filtering on the time axis to obtain the SEW element, and the SEW signal is subtracted from the entire signal as shown in Equation 2 below to easily obtain the REW element.

u_{REW}(n,φ)=u_{CW}(n,φ)−u_{SEW}(n,φ) (2)

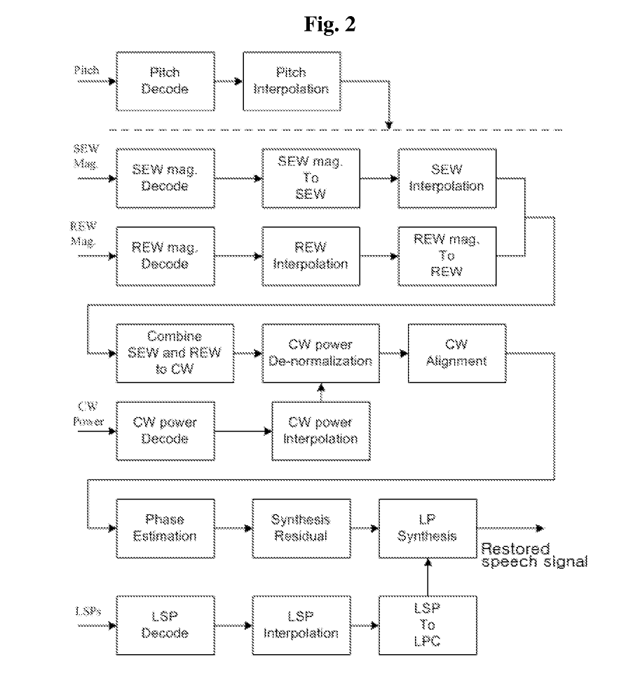

FIG. 2 is a decoder block diagram of the WI speech codec which is generally used.

The operation of a WI decoder in FIG. 2 is performed in the other way of the above-described operation of the encoder. Therefore, the operation may be simply described as follows. The existing WI decoder receives five parameters of LP coefficient, pitch, power of CW, and SEW and REW magnitudes. The decoder uses the LP coefficient, the pitch value, the power of CW, and the SEW and REW parameters to restore an original speech signal. First, the decoder interpolates successive SEW and REW parameters, and then synthesizes the two signals to restore the successive original CW. Then, a power de-normalization process of adding power to the restored CWs and a CW realignment process are performed, and a linear interpolation process of CWs and pitch values is performed. The finally obtained two-dimensional CW signal is converted in a LP residual signal of the one dimension. During such a conversion process, a calculation of predicting a phase track from the pitch value at each sample point is performed. When the residual signal of the one dimension passes through an LP synthesis filter, a final original speech signal is restored. The restored residual signal of the one dimension is used as an excitation signal of the LP synthesis filter for acquiring a speech signal as a final output.

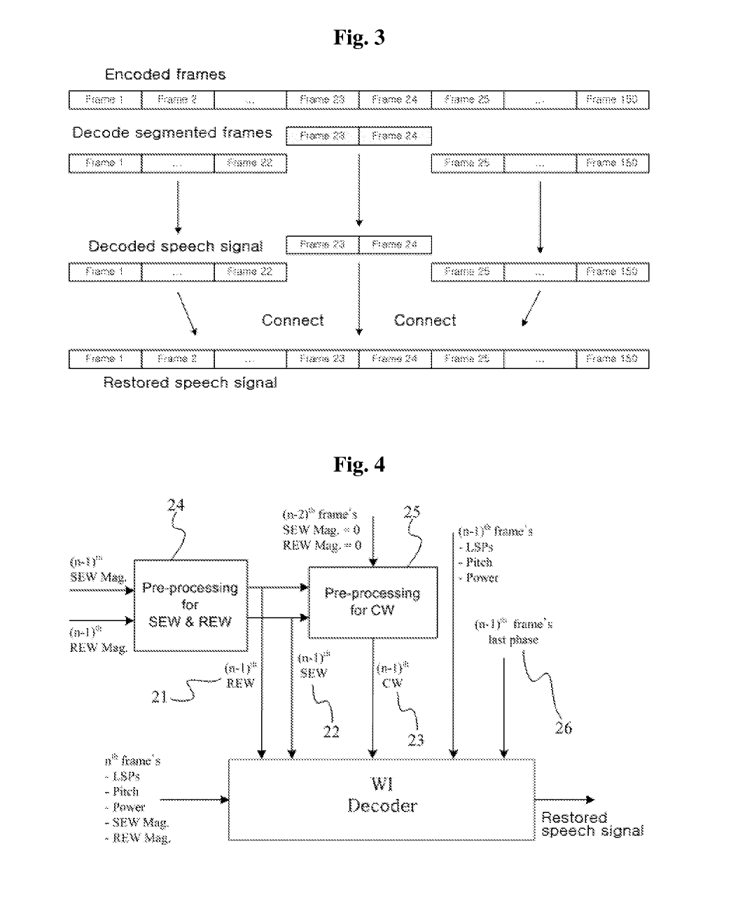

FIG. 3 is a diagram showing a process of decoding segmented speech frames. Referring to FIG. 3, a decoder used in a speech synthesizer should decode a specific frame containing a speech segment required by the synthesizer, among the encoded speech frames. That is, successive frames are not decided, but speech segments restored by decoding the segmented frames as shown in FIG. 3 are connected to restore a final speech signal. Therefore, when a speech signal corresponding to an intermediate speech segment of the connected speech signal is restored through an existing general decoder, a final speech output is significantly deteriorated. In particular, the speech output is very significantly deteriorated at a boundary where speech segments are connected.

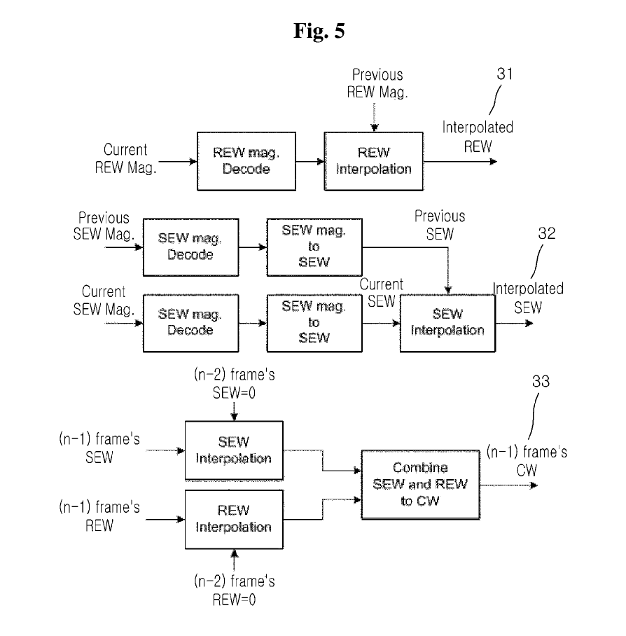

FIG. 4 is a diagram illustrating a decoder structure for decoding segmented speech frames in accordance with an embodiment of the present invention. FIG. 5 is a diagram illustrating the detailed structure of a pre-processing block of FIG. 4.

When parameters of a previous frame can be used in a first frame to be decoded during the decoding process of the segmented speech frames, it is possible to drastically reduce the above-described deterioration of speech quality. Therefore, the embodiment of the present invention has propose a new decoding method based on the existing WI decoder, which decodes a segmented frame by using parameters of a previous frame as shown in FIG. 4, thereby significantly improving a reduction in speech quality at a connection boundary.

Referring to FIG. 4, the decoder uses all parameters of an (n−1)-th frame, that is, an LSF coefficient, CW power, and SEW and REW magnitudes, in order to decode a segmented n-th frame. The decoder needs a CW of the (n−1)-th frame to process a first frame (23). However, since the CW of a current frame requires the SEW and REW of a previous frame, the SEW and REW of an (n−2)-th frame are required to acquire the CW of the (n−1)-th frame. Here, the (n−1)-th frame may be referred to as a previous speech frame, the n-th frame may be referred to as a current speech frame, and the (n−2)-th frame may be referred to as a previous speech frame of the previous speech frame.

In FIG. 4, a block 25 for generating the CW of the (n−1)-th frame interpolates the SEW and REW of the (n−1)-th frame as in (33) of FIG. 5, and then combines the interpolated SEW and REW to generate the CW. Furthermore, a block 24 for generating the SEW and REW of the (n−1)-th frame in FIG. 4 calculates the SEW and REW from SEW and REW magnitude parameters of the previous frame as in (31) and (32) of FIG. 5. That is, when successive frames are decoded, the decoder retains a previous CW signal at a decoding time of a current frame. Therefore, the CW signal of the previous frame may be used at all times. However, when segmented frames are decoded, the decoder does not have a previous CW signal at a first frame. Therefore, in order for decoding, the CW signal of the (n−1)-th frame should be generated by using the SEW and REW information of the (n−1)-th and (n−2)-th frames.

In the new decoding structure, phase information 26 of the last sample of the previous frame is used in addition to the above-described five parameters. The phase information of the last sample is used by interpolating phase information calculated for the first sample of the current frame. The phase information is calculated during a phase prediction process, and used for acquiring a one-dimensional residual signal from the two-dimensional CW signal. During the prediction process, the phase information of each sample is calculated, and the phase of the last sample is stored to decode the next frame. When such phase information is additionally used, the quality of the restored speech signal is significantly improved.

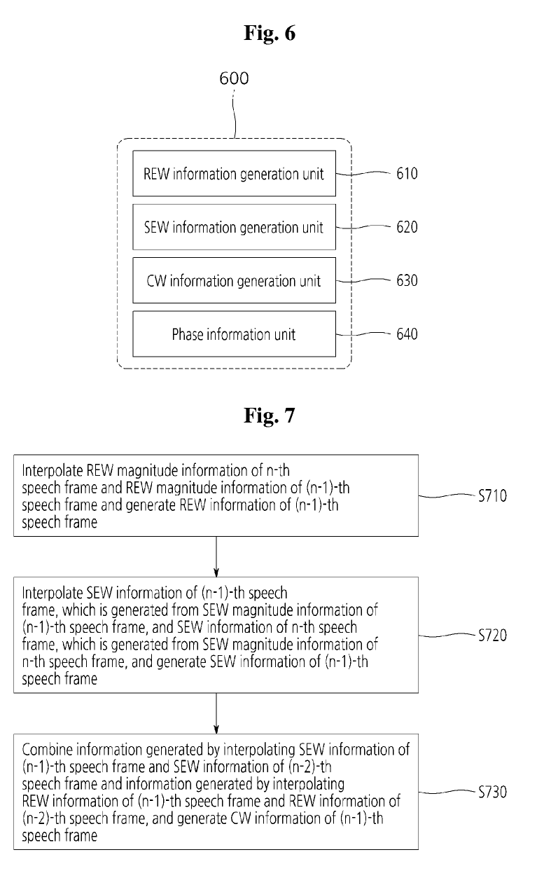

FIG. 6 is a block diagram of a decoder for decoding segmented speech frames in accordance with an embodiment of the present invention. Referring to FIG. 6, the decoder 600 includes an REW information generation unit 610, an SEW information generation unit 620, a CW information generation unit 630, and a phase information unit 640.

The REW information generation unit 610, the SEW information generation unit 620, the CW information generation unit 630, and the phase information unit 640 may serve as a pre-processing block configured to generate parameters of a segmented current speech frame by using parameters of a segmented previous speech frame.

Furthermore, the decoder 600 may further include a decoding unit configured to decode a speech frame by using the generated parameters of the current speech frame.

The REW information generation unit 610 is configured to interpolate REW magnitude information of an n-th speech frame and REW magnitude information of an (n−1)-th speech frame and generate REW information of the (n−1)-th speech frame.

The SEW information generation unit 620 is configured to interpolate SEW information of the (n−1)-th speech frame, which is generated from SEW magnitude information of the (n−1)-th speech frame, and SEW information of the n-th speech frame, which is generated from SEW magnitude information of the n-th speech frame, and generate SEW information of the (n−1)-th speech frame.

The CW information generation unit 630 is configured to combine information generated by interpolating the SEW information of the (n−1)-th speech frame and SEW information of an (n−2)-th speech frame and information generated by interpolating the REW information of the (n−1)-th speech frame and REW information of the (n−2)-th speech frame, and generate CW information of the (n−1)-th speech frame.

The phase information unit 640 is configured to interpolate phase information of a last sample and phase information calculated for a first sample of the n-th speech frame and decode the n-th speech frame by further using the phase information of the last sample of the (n−1)-th speech frame.

In this embodiment, an LP coefficient, a pitch value, CW power, the REW information, and the SEW information of the (n−1)-th speech frame may be further used to decode the n-th speech frame.

FIG. 7 is a flow chart showing a method for decoding segmented speech frames in accordance with an embodiment of the present invention. The following respective steps may be performed by the decoder for decoding segmented speech frames.

At step S710, REW magnitude information of an n-th speech frame and REW magnitude information of an (n−1)-th speech frame are interpolated to generate REW information of the (n−1)-th speech frame.

At step S720, SEW information of the (n−1)-th speech frame, which is generated from SEW magnitude information of the (n−1)-th speech frame, and SEW information of the n-th speech frame, which is generated from SEW magnitude information of the n-th speech frame, are interpolated to generate SEW information of the (n−1)-th speech frame.

At step S730, information generated by interpolating the SEW information of the (n−1)-th speech frame and SEW information of an (n−2)-th speech frame and information generated by interpolating the REW information of the (n−1)-th speech frame and REW information of the (n−2)-th speech frame are combined to generate CW information of the (n−1)-th speech frame. The generated CW information may be used for decoding the n-th speech frame.

The detailed descriptions of a specific decoding method for the decoder for decoding a segmented speech frame will be easily understood by those in the art, and are omitted herein.

The method for decoding segmented speech frames in accordance with the embodiment of the present invention may be embodied in program instruction forms which may be executed through a variety of computer units, and written in computer-readable media. That is, the recording medium may include a computer-readable recording medium configured to store a program which causes a computer to execute the respective steps.

The computer-readable media may also include, alone or in combination with program instructions, data files, data structures, and the like. The program instructions written in the media may include a program instruction which is specially designed or configured for the present invention or a program instruction which is well-known to those skilled in the art. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), RAM, flash memory, and the like.

The above-described respective components may be implemented by one part or different parts adjacent to each other. In the latter, the respective components may be positioned adjacent to each other or in different regions and then controlled. In this case, the present invention may include a separate control unit for controlling the respective components.

In accordance with the embodiments of the present invention, the speech decoder and method for decoding segmented speech frames, decode an arbitrary segmented frame without deterioration of speech quality.

While the present invention has been described with respect to the specific embodiments, it will be apparent to those skilled in the art that various changes and modifications may be made without departing from the spirit and scope of the invention as defined in the following claims.

What is claimed is:

1. A method for decoding segmented speech frames, comprising:
generating parameters of a segmented current speech frame by using parameters of a segmented previous speech frame; and
decoding a speech frame by using the parameters of the current speech frame, which are generated in the step of generating the parameters of the segmented current speech frame.

2. The method of claim 1, wherein the step of generating the parameters of the segmented current speech frame comprises:
interpolating rapidly evolving waveform (REW) magnitude information of the current speech frame and REW magnitude information of the previous speech frame and generating REW information of the previous speech frame;
interpolating slowly evolving waveform (SEW) information of the previous speech frame, which is generated from SEW magnitude information of the previous speech frame, and SEW information of the current speech frame, which is generated from SEW magnitude information of the current speech frame, and generating SEW information of the previous speech frame; and
combining information generated by interpolating the SEW information of the previous speech frame and SEW information of a speech frame before the previous speech frame and information generated by interpolating the REW information of the previous speech frame and REW information of the speech frame before the previous speech frame, and generating characteristic waveform (CW) information of the previous speech frame.

3. The method of claim 1, wherein, in the step of generating the parameters of the segmented current speech frame, a linear prediction (LP) coefficient, a pitch value, CW power, REW information, and SEW information of the previous speech frame are further used to generate the parameters of the current speech frame.

4. The method of claim 1, wherein, in the step of generating the parameters of the segmented current speech frame, phase information of a last sample of the previous speech frame is further used to generate the parameters of the current speech frame.

5. The method of claim 4, wherein the step of generating the parameters of the segmented current speech frame comprises interpolating the phase information of the last sample and phase information calculated for a first sample of the current speech frame.

6. A speech decoder for decoding segmented speech frames, comprising:
a preprocessing block configured to generate parameters of a segmented current speech frame by using parameters of a segmented previous speech frame; and
a decoding block configured to decode a speech frame by using the parameters of the current speech frame which are generated by the preprocessing block.

7. The speech decoder of claim 6, wherein the preprocessing block comprises:
an REW information generation unit configured to interpolate REW magnitude information of the current speech frame and REW magnitude information of the previous speech frame and generate REW information of the previous speech frame;
an SEW information generation unit configured to interpolate SEW information of the previous speech frame, which is generated from SEW magnitude information of the previous speech frame, and SEW information of the current speech frame, which is generated from SEW magnitude information of the current speech frame, and generate SEW information of the previous speech frame; and
a CW information generation unit configured to combine information generated by interpolating the SEW information of the previous speech frame and SEW information of a speech frame before the previous speech frame and information generated by interpolating the REW information of the previous speech frame and REW information of the speech frame before the previous speech frame, and generate CW information of the previous speech frame.

8. The speech decoder of claim 6, wherein the preprocessing block generates the parameters of the current speech frame by further using an LP coefficient, a pitch value, CW power, REW information, and SEW information of the previous speech frame.

9. The speech decoder of claim 6, wherein the preprocessing block generates the parameters of the current speech frame by further using phase information of a last sample of the previous speech frame.

10. The speech decoder of claim 9, wherein the preprocessing block comprises a phase information unit configured to interpolate the phase information of the last sample and phase information calculated for a first sample of the current speech frame.
